(19) United States
(12) Patent Application Publication
(10) Pub. No.: US 2019/0250289 A1
(43) Pub. Date: Aug. 15, 2019

(54) NOVEL SYSTEM AND RELATED METHODS FOR PERFORMING SEISMIC SURVEYS

(71) Applicant: INOVALTD., George Town (KY)

(72) Inventor: Andrew BULL, Scotland (GB)

(21) Appl. No.: 16/314,611

(22) PCT Filed: Jul. 27, 2017
(86) PCT No.: PCT/US2017/044126

§ 371 Date: Dec. 31, 2018

Related U.S. Application Data
(60) Provisional application No. 62/371,439, filed on Aug. 5, 2016.

(51) Int. Cl. G01V 1/04; G01V 1/00; G01V 1/147; G01V 1/30

(52) U.S. Cl. CPC G01V 1/04; G01V 1/003; G01V 2210/1295; G01V 1/30; G01V 1/147

(57) ABSTRACT

A vehicle adapted for seismic survey operations includes a hybrid engine, which has an internal combustion mode and an electrical power mode. The engine operating mode is selected based on the activity in which the vehicle is engaging. During movement, the internal combustion mode may be used and during seismic sweeping, the electrical power mode may be used. In variants, the electrical power may be used during movement.

### BACKGROUND OF THE DISCLOSURE

### 1. Field of the Disclosure

This disclosure relates generally to systems and methods for selectively energizing a seismic source using a hybrid power source.

### 2. Background of the Art

Seismic surveys are conducted to map subsurface structures to identify and develop oil and gas reservoirs. Seismic surveys are typically performed to estimate the location and quantities of oil and gas fields prior to developing (drilling wells) the fields and also to determine the changes in the reservoir over time subsequent to the drilling of wells. Many geophysical surveys are performed using a seismic source carried by a truck and positioned at a predetermined location in an area of exploration. The seismic source can be a single axis vibratory source and can impart compressing P-waves and S-waves into the earth once coupled to the earth and operated. The vibrator transmits force energy into the ground using a baseplate and a reaction mass.

Conventional vibrator trucks use an internal combustion engine (e.g., a diesel engine) that is used to move the truck as well as supply the power necessary to operate the seismic source. The noise from operating the engine interferes with the collection of seismic data creating noise patterns that are difficult to remove. The present disclosure provides a novel system and method for performing seismic surveys that minimizes or eliminates such noise.

### SUMMARY OF THE DISCLOSURE

In aspects, the present disclosure provides a method for performing a seismic survey. The method may include positioning a vehicle having a seismic source, an internal combustion engine, and an electric engine at a selected location; and performing the seismic survey by energizing the seismic source with only the electric engine.

In aspects, the present disclosure also provides a vehicle for performing a seismic survey. The vehicle may include a seismic source; an internal combustion engine; an electric engine operatively connected to the seismic source; and a controller configured to switch a supply of power from either the internal combustion engine or the electric engine to the seismic source.

Examples of certain features of the systems, methods and apparatus disclosed herein have been summarized rather broadly in order that detailed description thereof that follows may be better understood, and in order that the contributions to the art may be appreciated. There are, of course, additional features of the disclosure that will be described hereinafter and will form the subject of the disclosure. The summary provided herein is not intended to limit the scope.

### BRIEF DESCRIPTION OF THE DRAWINGS

The novel features of this disclosure, as well as the disclosure itself, will be best understood from the attached drawings, taken along with the following description, in which similar reference characters generally refer to similar elements, and in which:

FIG. 1 schematically illustrates one embodiment of a truck in accordance with the present disclosure;

FIG. 2 illustrates a method according to the present disclosure; and

FIG. 3 illustrates a method according to the present disclosure that uses a hybrid vehicle.

### DETAILED DESCRIPTION

The present disclosure relates to devices and methods for controlling activities relating to seismic data acquisition. The present disclosure may be implemented in embodiments of different forms. The drawings shown and the descriptions provided herein correspond to certain specific embodiments of the present disclosure for the purposes of explanation of the concepts contained in the disclosure with the understanding that the present disclosure is to be considered an exemplification of the principles of the disclosure, and is not intended to limit the scope of the disclosure to the illustrated drawings and the description herein.

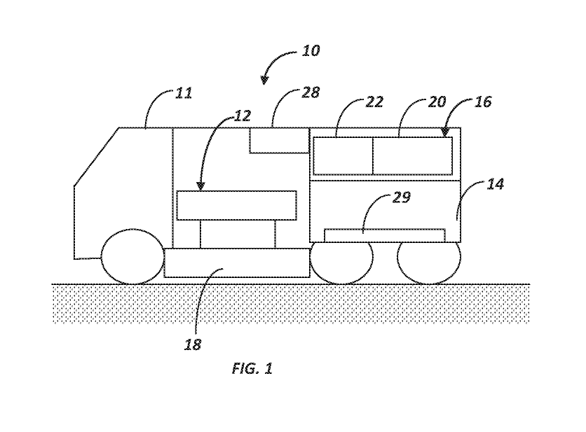

FIG. 1 schematically illustrates one non-limiting seismic vehicle 10 in accordance with the present disclosure. The vehicle 10 may include a body 11 on which are positioned a seismic source 12, an internal combustion engine 14, and an electric engine 16. The seismic source 12 includes a hydraulic subsystem used to move a reaction mass. The moving reaction mass acts upon a base plate 18 to impart a seismic source signal into the earth. The electric engine 16 may include a battery 20 and an engine 22 that outputs motive power, such as rotary power or reciprocating power. A drive train 29 may be selectively connected to either or both of the internal combustion engine 14 and the electric engine 16. The drive train 29 uses the delivered motive power to move the vehicle 10. Advantageously, the electric engine 16 is operatively connected to and energizes the seismic source 12 during operation, as discussed in greater detail below. By “energize,” it is meant to supply the principal source of the energy used by the consuming device (e.g., the seismic source) to perform a specified function.

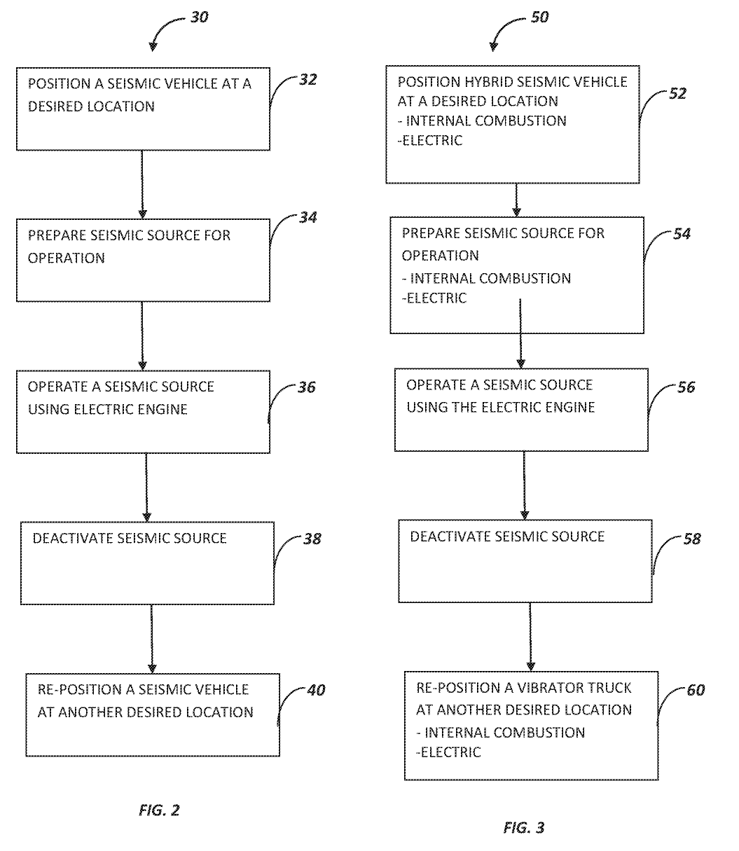

FIG. 2 is a flow chart depicting one method 30 according to the present disclosure. Referring to FIGS. 1 and 2, at step 32, the vehicle 10 is driven using the power of the internal combustion engine 14 to a desired location, which is typically a pre-planned source point. That is, the internal combustion engine 14 is connected to and driving the drive train 29. At step 34, the seismic source 12 is prepared for operation by moving the baseplate 18 of the seismic source 12 to ground, applying weight to the baseplate 18, and using the electric engine 16 to energize the seismic source 12; e.g., the electric engine 16 may drive hydraulic pumps that “pressure up” the hydraulic fluid used by the seismic source 12. Alternatively, the internal combustion engine 14 may be used to during this step. In either case, at step 36, the seismic survey commences with only the electric engine 16 in operation. The survey may include vibroseis sweeps lasting ten to thirty seconds. During this time, the internal combustion engine 14 is not operating and therefore does not create noise. At step 38, the survey operation is ended and the seismic source 12 is deactivated; i.e., the seismic source 12 is depressurized (or “pressured down”), weight on the baseplate is released, and the baseplate 18 is picked up. At step 40, the vehicle 10 can move to another location using the internal combustion engine 14.

In some embodiments, the electric engine 16 may be a modular system that may be carried onboard the vehicle 10. That is, the electric engine 16 may be a system that is independent of the vehicle 10. In other embodiments, the vehicle 10 may incorporate a hybrid engine arrangement wherein the electric engine 16 can also be used to propel the vehicle 10. That is, the electric engine 16 is selectively and operatively coupled to provide rotary power to the drive train 29 and to the seismic source 12. Referring to FIG. 1, a controller 28 may be used to select either the internal combustion engine 16 or the electric engine 16 as the power source for the vehicle 10 and/or the seismic source 12. In some embodiments, the controller 28 may be manually operated. That is, personnel may use the controller 28 to switch power sources depending on the operating mode of the vehicle 10 (e.g., moving or sweeping). In other embodiments, the controller 28 may be programmed to automatically select the appropriate power source based on the operating mode of the vehicle 10.

FIG. 3 is a flow chart depicting one method 30 according to the present disclosure that uses a hybrid seismic vehicle 10. Referring to FIGS. 1 and 3, at step 52, the vehicle 10 moves using the power of the internal combustion engine 14 to a desired location. During this transit, the internal combustion engine 14 may be used to charge the electric engine 16. At step 54, the seismic source 12 is prepared for operation by moving the baseplate 18 of the seismic source 12 to ground, applying weight to the baseplate 18, and using the electric engine 16 to energize the seismic source 12. Either the internal combustion engine 14 or the electric engine 16 is used during this preparation. At step 56, the seismic survey commences by only operating the electric engine 16 and deactivating the internal combustion engine 14. During the survey, the internal combustion engine 14 is not operating and therefore does not create noise. At step 58, the survey operation is ended and the seismic source 12 is deactivated. At step 60, survey operations are completed and the vehicle 10 may transit to another location using the internal combustion engine 14. The internal combustion engine 14 may be used to charge the electric engine 16 during the transit. It should be noted that the movement of the vehicle at steps 52 and 60 may be done using the electric engine 16.

From the above, it should be appreciated that embodiments of the present disclosure utilize a vehicle that has a hybrid engine. The engine has an internal combustion mode and an electrical power mode. The engine operating mode is selected based on the activity in which the vehicle is engaging. For instance, during movement the internal combustion mode is used and during seismic sweeping, the electrical power mode is used. In variants, the electrical power may be used during movement.

It should be appreciated that the teachings of the present disclosure provide several advantages over conventional seismic survey operations. For instance, electric engines 16 are significantly less noisy than the internal combustions engine 14. By way of example, a diesel engine may have mid-range RPM's during movement and high RPM's when energizing the seismic source 12. The noise emissions associated with such RPM's can interfere with and degrade data acquired during geophysical recording activity. Using an electric engine in lieu of an internal combustion engine 14 for supplying power reduces or eliminates such interference and data degradation. Moreover, the option of moving the vehicle 10 under electric power can alleviate concerns with environment noise pollution, which may affect nearby communities. A hybrid engine arrangement can also reduce pollution and improve the fuel efficiency of the vehicle 10.

As referred to above, an internal combustion engine is an engine that generates motive power by combusting a fuel such as gasoline, oil, or other fuel with air inside the engine. The hot gases generated during this process is used to drive a piston or do other work. As referred to above, an electric engine is a machine that converts electrical energy into mechanical energy. The electrical energy may be a local battery or a continuous supply. In the above discussion, it should be understood that reference to an engine providing energy to a particular device means that only that engine is providing energy. The other engine is disconnected from that particular device and not providing energy to that device.

The disclosure herein is provided in reference to particular embodiments and processes to illustrate the concepts and methods. Such particular embodiments and processes are not intended to limit the scope of the disclosure or the claims. All such modifications within the scope of the claims and disclaimers are intended to be part of this disclosure.

What is claimed is:

1. A method for performing a seismic survey, comprising:
positioning a vehicle having a seismic source, an internal combustion engine, and an electric engine at a selected location; and
performing the seismic survey by energizing the seismic source with only the electric engine.

2. The method of claim 1, wherein the positioning is performed by moving the vehicle using only the internal combustion engine.

3. The method of claim 2, further comprising re-positioning the vehicle using only the electric engine.

4. The method of claim 1, wherein the positioning is performed by moving the vehicle using only the electric engine.

5. The method of claim 1, wherein the internal combustion engine charges the electric engine during the positioning.

6. The method of claim 1, further comprising deactivating the internal combustion engine before performing the seismic survey.

7. The method of claim 1, further comprising pressurizing a hydraulic fluid used by the seismic source using the electric engine.

8. The method of claim 1, further comprising pressurizing a hydraulic fluid used by the seismic source using the internal combustion engine.

9. A vehicle for performing a seismic survey, comprising:
a vehicle body;
a seismic source positioned on the vehicle body;
an internal combustion engine positioned on the vehicle body;
an electric engine operatively connected to the seismic source; and
a controller configured to switch a supply of power from either the internal combustion engine or the electric engine to the seismic source.

10. The vehicle of claim 9, wherein the internal combustion engine and the electric engine are configured to move the vehicle body.

11. The vehicle of claim 9, wherein the internal combustion engine is configured to charge the electric engine.

12. The vehicle of claim 9, further comprising a drive train positioned on the vehicle body, the drive train being selectively connected to one of the internal combustion engine and the electric engine.

13. The vehicle of claim 9, further wherein the electric engine is configured to pressurizing a hydraulic fluid used by the seismic source.
